(19) United States
(12) Patent Application Publication
(10) Pub. No.: US 2014/0079990 A1
(43) Pub. Date: Mar. 20, 2014

(54) NONAQUEOUS ELECTROLYTE BATTERY

(71) Applicants: Katsunori Yanagida, Hyogo (JP); Motoharu Saito, Osaka (JP)

(72) Inventors: Katsunori Yanagida, Hyogo (JP); Motoharu Saito, Osaka (JP)

(73) Assignee: SANYO ELECTRIC CO., LTD., Moriguchi-shi, Osaka (JP)

(21) Appl. No.: 14/116,589

(22) PCT Filed: May 22, 2012
(86) PCT No.: PCT/JP2012/062980

§ 371 Date: Nov. 8, 2013

(30) Foreign Application Priority Data
May 31, 2011 (JP) 2011-121941
Feb. 29, 2012 (JP) 2012-042877

(51) Int. Cl. H01M 4/485; H01M 10/0566

(52) U.S. Cl. CPC H01M 4/485; H01M 10/0566
USPC 429/200

(57) ABSTRACT

The present invention provides a nonaqueous electrolyte battery having a high charge-discharge efficiency. The nonaqueous electrolyte battery of the present invention is a nonaqueous electrolyte battery including a positive electrode containing a positive electrode active material, a negative electrode, and a nonaqueous electrolyte, the positive electrode active material contains a lithium transition metal oxide having a crystalline structure belonging to the P6₃mc space group, and the nonaqueous electrolyte contains a fluorinated cyclic carbonate ester and a fluorinated chain ester.

### TECHNICAL FIELD

The present invention relates to a nonaqueous electrolyte battery.

### BACKGROUND ART

As one next-generation high-capacity positive electrode active material, a lithium transition metal oxide formed by ion exchange of a sodium transition metal oxide has been currently investigated (see Non-Patent Literature 1).

In LiCoO₂ which has a crystalline structure belonging to the R-3m space group and which has been currently used in practice, when charge is performed so that the positive electrode potential exceeds 4.6 V (vs. Li/Li⁺), since approximately 70% or more of lithium in LiCoO₂ is extracted therefrom, the crystalline structure collapses, and the charge-discharge efficiency is decreased. On the other hand, in LiCoO₂ which is one type of lithium transition metal oxide formed by ion exchange of a sodium transition metal oxide and which has a crystalline structure belonging to the P6₃mc space group, when charge is performed so that the positive electrode potential exceeds 4.6 V (vs. Li/Li⁺), although approximately 80% of lithium in LiCoO₂ is extracted therefrom, the crystalline structure does not so much collapse.

However, it is difficult to form LiCoO₂ having a crystalline structure belonging to the P6₃mc space group. This LiCoO₂ may be obtained in such a way that after Na_{0.7}CoO₂ having the P2 structure is formed, the sodium thereof is ion-exchanged with lithium; however, when the temperature at the ion exchange is more than 150° C., the crystalline structure of LiCoO₂ is changed to the R-3m space group, and when the temperature is too low, the raw material used before the ion exchange may unfavorably remain.

### CITATION LIST

### Non-Patent Literature

NPL 1: Solid State Ionics 144 (2001) 263

### SUMMARY OF INVENTION

### Technical Problem

An object of the present invention is to provide a nonaqueous electrolyte battery having a high charge-discharge efficiency.

### Solution to Problem

A nonaqueous electrolyte battery according to one aspect of the present invention is a nonaqueous electrolyte battery comprising: a positive electrode containing a positive electrode active material; a negative electrode; and a nonaqueous electrolyte, the positive electrode active material contains a lithium transition metal oxide having a crystalline structure belonging to the P6₃mc space group, and the nonaqueous electrolyte contains a fluorinated cyclic carbonate ester and a fluorinated chain ester.

As the lithium transition metal oxide, a lithium transition metal oxide represented by Liₓ₁Na_{y1}Co_{α}M_{β}O_{γ} (0<x1<1.1, 0<y1≦0.05, 0.75≦α<1, 0<β≦0.25, 1.9≦γ≦2.1, and M indicates a metal element other than Co and includes at least Mn) is preferably used.

When x1 is larger than the above range, lithium is incorporated in the transition metal site, and the capacity density may be decreased in some cases. If y1 is larger than the above range, when sodium is inserted into or extracted from the transition metal oxide, the crystalline structure thereof is liable to collapse. In addition, when y1 is in the above range, the sodium may not be detected by XRD measurement in some cases.

When a is smaller than the above range, the average discharge potential is liable to decrease. In addition, if a is larger than the above range, when charge is performed so that the positive electrode potential reaches 4.6 V (vs Li/Li⁺) or more, the crystalline structure is liable to collapse. In addition, when 0.80≦α<0.95 is satisfied, it is more preferable since the energy density is further increased. In addition, when β is larger than the above range, the average discharge potential is liable to decrease.

The lithium transition metal oxide may include an oxide which belongs to the C2/m, the C2/c, or the R-3m space group. As these oxides, for example, Li₂MnO₃, LiCoO₂ having a crystalline structure belonging to the R-3m space group, and LiNiₐCo_{b}Mn_{c}O₂ (0<a<1, 0<b<1, 0<c<1) may be mentioned.

At least one element selected from the group consisting of magnesium, nickel, zirconium, molybdenum, tungsten, aluminum, chromium, vanadium, cerium, titanium, iron, potassium, gallium, and indium may be added to the lithium transition metal oxide. The addition amount of these elements mentioned above is preferably 10 percent by mole or less with respect to the total molar amount of cobalt and manganese.

It is possible to cover the surface of the positive electrode active material with fine particles of an inorganic compound. As the inorganic compound, for example, an oxide, a phosphate compound, and a boric acid compound may be mentioned. In addition, as the oxide, for example, Al₂O₃ may be mentioned.

The lithium transition metal oxide may be formed by ion exchange of sodium of a sodium transition metal oxide with lithium, the sodium transition metal oxide containing sodium, lithium in a molar amount not more than that of the sodium, cobalt, and manganese. For example, the lithium transition metal oxide may be formed by ion exchange of a part of sodium of a sodium transition metal oxide represented by Liₓ₂Na_{y2}Co_{α}M_{β}O_{γ} (0<x2≦0.1, 0.66<y2<0.75, 0.75≦α<1, 0<β≦0.25, 1.9≦γ≦2.1, and M indicates a metal element other than Co and includes at least Mn) with lithium. In addition, as for the above x2, 0.025≦x2≦0.050 is preferably satisfied.

The sodium transition metal oxide mentioned above is obtained in such a way that, for example, after Li₂CO₃, NaNO₃, Co₃O₄, and Mn₂O₃ are mixed together to have a desired stoichiometric ratio, the mixture thus prepared is held in the air at 800° C. to 900° C. for 10 hours.

Charge can be performed until the positive electrode of the present invention has a positive electrode potential of more than 4.6 V (vs. Li/Li⁺). Although the upper limit of the charge potential of the positive electrode is not particularly determined, when the upper limit is too high, for example, decomposition of a nonaqueous electrolyte may be induced, and hence, the upper limit is preferably set to 5.0 V (vs. Li/Li⁺) or less.

In addition, when charge is performed until the lithium transition metal oxide represented by the above general formula has a potential of more than 4.6 V (Li/Li⁺), the value of x1 is set so as to satisfy 0<x1<0.1.

The fluorinated cyclic carbonate ester is preferably a fluorinated cyclic carbonate ester in which a fluorine atom is directly bonded to a carbonate ring, and as this carbonate ester, for example, 4-fluorethylene carbonate, 4,5-difluoroethylene carbonate, 4,4-difluoroethylene carbonate, 4,4,5-trifluoroethylene carbonate, and 4,4,5,5-tetrafluoroethylene carbonate may be mentioned. Among those mentioned above, 4-fluorethylene carbonate and 4,5-difluoroethylene carbonate are more preferable since the viscosity thereof is relatively low, and a protective film is likely to be formed on the negative electrode.

The content of the fluorinated cyclic carbonate ester is preferably 5 to 50 percent by volume with respect to the total volume of the nonaqueous electrolyte and is more preferably 10 to 40 percent by volume.

The fluorinated chain ester preferably includes at least one of a fluorinated chain carboxylate ester and a fluorinated chain carbonate ester.

As the fluorinated chain carboxylate ester, for example, methyl acetate, ethyl acetate, propyl acetate, methyl propionate, or ethyl propionate, hydrogen atoms of each of which are partially or fully replaced with fluorine atoms, may be mentioned. Among those mentioned above, methyl 3,3,3-trifluoropropionate is preferable since the viscosity thereof is relatively low.

As the fluorinated chain carbonate ester, for example, dimethyl carbonate, ethyl methyl carbonate, diethyl carbonate, methyl propyl carbonate, ethyl propyl carbonate, or methyl isopropyl carbonate, hydrogen atoms of each of which are partially or fully replaced with fluorine atoms, may be mentioned. Among those mentioned above, methyl 2,2,2-trifluoroethyl carbonate is preferable.

The content of the fluorinated chain ester is preferably 30 to 90 percent by volume with respect to the total volume of the nonaqueous electrolyte and is more preferably 50 to 90 percent by volume.

For the nonaqueous electrolyte of the present invention, besides the fluorinated cyclic carbonate ester and the fluorinated chain ester mentioned above, for example, a related nonaqueous electrolyte which has been used for nonaqueous electrolyte batteries may also be used together with the nonaqueous electrolyte of the present invention. As the related nonaqueous electrolyte, for example, a cyclic carbonate ester, a chain carbonate ester, and an ether may be mentioned. As the cyclic carbonate ester, for example, ethylene carbonate and propylene carbonate may be mentioned. As the chain carbonate ester, for example, dimethyl carbonate, ethyl methyl carbonate, and diethyl carbonate may be mentioned. As the ether, for example, 1,2-dimethoxy ethane may be mentioned.

In the nonaqueous electrolyte used in the present invention, for example, a related alkaline metal salt which has been used for nonaqueous electrolyte batteries may be contained. As the related alkaline metal salt, for example, LiPF₆ and LiBF₄ may be mentioned.

As a negative electrode active material used in the present invention, for example, a related negative electrode active material which has been used for nonaqueous electrolyte batteries may be used. As the related negative electrode active material, for example, graphite, lithium, silicon, and a silicon alloy may be mentioned.

For the nonaqueous electrolyte battery of the present invention, if necessary, for example, battery constituent members which have been used for related nonaqueous electrolyte batteries may also be used.

### Advantageous Effects of Invention

According to the present invention, a coating film which enables insertion and extraction of lithium to be smooth is formed on the positive electrode active material, and the charge-discharge efficiency is improved.

### BRIEF DESCRIPTION OF DRAWINGS

FIG. 1 is a powder x-ray diffraction pattern of a positive electrode active material formed in Example 1.

FIG. 2 is a schematic view of a test cell used in Examples and Comparative Examples.

### DESCRIPTION OF EMBODIMENT

Hereinafter, although an embodiment of the present invention will be described in detail by way of example, the present invention is not limited to the following examples.

[Experiment 1]

[Formation of Test Cell]

### EXAMPLE 1

NaNO₃, CO₃O₄, and Mn₂O₃ were mixed together to have a stoichiometric ratio of Na_{0.7}Co_{5/6}Mn_{1/6}O₂. Subsequently, the mixture thus prepared was held in the air at 900° C. for 10 hours, so that a sodium transition metal oxide was obtained.

A molten salt bed obtained by mixing LiNO₃ and LiOH at a molar ratio of 61 to 39 was added in an amount of five times equivalent to 5 g of the sodium transition metal oxide thus obtained and was held at 200° C. for 10 hours, so that a part of the sodium of the sodium transition metal oxide was ion-exchanged with lithium. Furthermore, a substance obtained by the ion exchange was washed with water, so that a lithium transition metal oxide was obtained.

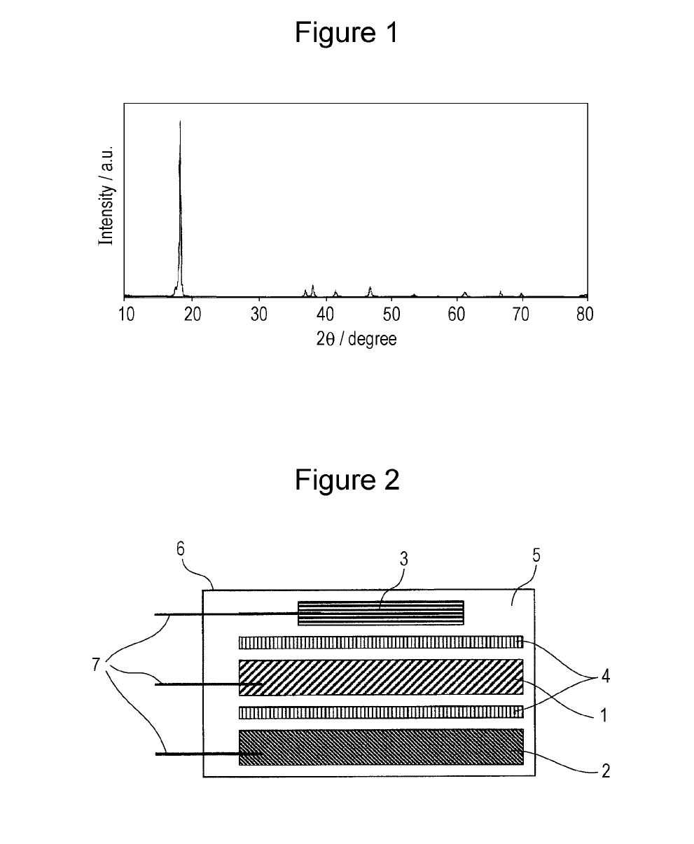

According to the analytical result obtained by a powder x-ray diffraction method, it was found that the lithium transition metal oxide thus obtained had a crystalline structure belonging to the P6₃mc space group (see FIG. 1). In addition, when quantitative determination of cobalt and manganese and that of lithium and sodium were performed by an ICP emission analysis and an atomic absorption analysis, respectively, it was found that the composition of the lithium transition metal oxide thus obtained was represented by Li_{0.8}Na_{0.03}Mn_{5/6}Co_{1/6}O₂.

The lithium transition metal oxide thus obtained was used as a positive electrode active material, and the positive electrode active material, acetylene black functioning as a conductive agent, and a poly(vinylidene fluoride) functioning as a binder were mixed together to have a mass ratio of 90:5:5. Subsequently, N-methyl-2-pyrrolidone was added to the mixture thus formed, so that a positive electrode mixture slurry was formed. The positive electrode mixture slurry thus obtained was applied on a collector formed of an aluminum foil and was dried in vacuum at 110° C., so that a working electrode 1 was formed.

In an argon atmosphere, a test cell shown in FIG. 2 was formed using the working electrode 1, a counter electrode 2, a reference electrode 3, separators 4, a nonaqueous electrolyte 5, and a container 6. In addition, a lithium metal was used for the counter electrode 2 and the reference electrode 3. A polyethylene-made separator was used as the separator 4. As the nonaqueous electrolyte 5, a solution was used which was prepared by dissolving LiPF₆ in a nonaqueous electrolyte containing 4-fluorethylene carbonate (FEC) and methyl 3,3,3-trifluoropropionate (F-MP) at a volume ratio of 2 to 8 to have a concentration of 1.0 mol/l. A current collector tab 7 was fitted to each of the working electrode 1, the counter electrode 2, and the reference electrode 3.

### EXAMPLE 2

A test cell was formed in a manner similar to that in Example 1 except that as the nonaqueous electrolyte, a solution was used which was obtained by dissolving LiPF₆ in a nonaqueous electrolyte containing 4,5-difluoroethylene carbonate (DFEC) and methyl 3,3,3-trifluoropropionate (F-MP) at a volume ratio of 2 to 8 to have a concentration of 1.0 mol/l.

### EXAMPLE 3

A test cell was formed in a manner similar to that in Example 1 except that as the nonaqueous electrolyte, a solution was used which was obtained by dissolving LiPF₆ in a nonaqueous electrolyte containing 4-fluoroethylene carbonate (FEC) and methyl 2,2,2-trifluoroethyl carbonate (F-EMC) at a volume ratio of 2 to 8 to have a concentration of 1.0 mol/l.

### COMPARATIVE EXAMPLE 1

A test cell was formed in a manner similar to that in Example 1 except that as the nonaqueous electrolyte, a solution was used which was obtained by dissolving LiPF₆ in a nonaqueous electrolyte containing ethylene carbonate (EC) and ethyl methyl carbonate (EMC) at a volume ratio of 2 to 8 to have a concentration of 1.0 mol/l.

### COMPARATIVE EXAMPLE 2

After Li CO₂ and Co₂O₄ were mixed together, the mixture thus formed was held in the air at 900° C. for 10 hours, so that LiCoO₂ was obtained. According to the analytical result obtained by a powder x-ray diffraction method, it was found that the LiCoO₂ thus obtained had a crystalline structure belonging to the R-3m space group.

A test cell was formed in a manner similar to that in Example 3 except that the LiCoO₂ thus obtained was used as the positive electrode active material.

### COMPARATIVE EXAMPLE 3

A test cell was formed in a manner similar to that in Comparative Example 2 except that as the nonaqueous electrolyte, a solution was used which was obtained by dissolving LiPF₆ in a nonaqueous electrolyte containing ethylene carbonate (EC) and ethyl methyl carbonate (EMC) at a volume ratio of 2 to 8 to have a concentration of 1.0 mol/l. The details of the individual test cells are shown in Table 1.

TABLE 1

| | Positive Electrode | | Nonaqueous |
|---|---|---|---|
| | Active Material | Crystalline | Electrolyte |
| | Composition | Structure | (Volume Ratio) |
| Example 1 | Li_{0.8}Na_{0.03}Co_{5/6}Mn_{1/6}O₂ | P6₃mc | 1M LiPF₆ |
| | | | FEC/F-MP (2/8) |
| Example 2 | Li_{0.8}Na_{0.03}Co_{5/6}Mn_{1/6}O₂ | P6₃mc | 1M LiPF₆ |
| | | | DFEC/F-MP (2/8) |
| Example 3 | Li_{0.8}Na_{0.03}Co_{5/6}Mn_{1/6}O₂ | P6₃mc | 1M LiPF₆ |
| | | | FEC/F-EMC (2/8) |
| Comparative | Li_{0.8}Na_{0.03}Co_{5/6}Mn_{1/6}O₂ | P6₃mc | 1M LiPF₆ |
| Example 1 | | | EC/EMC (2/8) |
| Comparative | LiCoO₂ | R-3m | 1M LiPF₆ |
| Example 2 | | | FEC/F-EMC (2/8) |
| Comparative | LiCoO₂ | R-3m | 1M LiPF₆ |
| Example 3 | | | EC/EMC (2/8) |

[Charge-Discharge Cycle Test]

The test cells of Examples 1 to 3 and Comparative Examples 1 to 3 were evaluated as follows. After the test cell was charged at a constant current of 0.2 It until the positive electrode potential reached 4.8 V (vs. Li/Li⁺) (in Comparative Examples 2 and 3, 4.6 V (vs. Li/Li⁺)), charge was performed at a constant voltage of 4.8 V (vs. Li/Li⁺) (in Comparative Examples 2 and 3, 4.6 V (vs. Li/Li⁺)) until the current reached 0.05 It. Subsequently, discharge was performed at a constant current of 0.2 It until the positive electrode potential reached 3.2 V (vs. Li/Li⁺). A value obtained by dividing the discharge capacity by the charge capacity was multiplied by 100 to obtain the charge-discharge efficiency (%), and the results are shown in Table 2.

In addition, the reason the upper limit of the charge potential of the positive electrode of the test cell of each of Comparative Examples 2 and 3 was set to 4.6 V (vs. Li/Li⁺) is that it has been known that the crystalline structure of LiCoO₂ used as the positive electrode active material was unstable at a high potential of more than 4.6 V (vs. Li/Li⁻).

TABLE 2

| | Charge | Discharge | Charge-Discharge |
|---|---|---|---|
| | Capacity | Capacity | Efficiency |
| | (mAh/g) | (mAh/g) | (%) |
| Example 1 | 220 | 216 | 98.2 |
| Example 2 | 220 | 216 | 98.2 |
| Example 3 | 219 | 215 | 98.2 |
| Comparative | 215 | 208 | 96.7 |
| Example 1 | | | |
| Comparative | 212 | 205 | 96.7 |
| Example 2 | | | |
| Comparative | 215 | 208 | 96.7 |
| Example 3 | | | |

When Comparative Examples 2 and 3 shown in Table 2 are compared to each other, it is found that in the test cell which uses a positive electrode active material having a crystalline structure belonging to the R-3m structure, even when FEC and F-EMC are used as the nonaqueous electrolyte, the charge-discharge efficiency is not improved. On the other hand, when Example 3 and Comparative Example 1 shown in Table 2 are compared to each other, it is found that in the test cell which uses a positive electrode active material having the P6₃mc structure, when FEC and F-EMC are used as the nonaqueous electrolyte, the charge-discharge efficiency is improved. The reason for this is believed that when a fluorinated cyclic carbonate ester and a fluorinated chain ester are used in combination with a positive electrode active material having a crystalline structure belonging to the P6₃mc structure, although a coating film which enables insertion and extraction of lithium to be smooth is formed on the positive electrode active material, when a fluorinated cyclic carbonate ester and a fluorinated chain ester are used in combination with a positive electrode active material having a crystalline structure belonging to the R-3m structure, a coating film similar to that described above is not formed. In addition, in Examples 1 and 2, it is found that the charge-discharge efficiency is also improved as that in Example 3.

When Comparative Examples 2 and 3 shown in Table 2 are compared to each other, the charge capacity of the test cell of Comparative Example 2 in which FEC and F-EMC are used as the nonaqueous electrolyte is smaller than that of the test cell of Comparative Example 3 in which FEC and F-EMC are not used. The reason for this is believed that although a fluorinated cyclic carbonate ester and a fluorinated chain ester are used in combination with a positive electrode active material having a crystalline structure belonging to the R-3m structure, a coating film similar to that described above is not formed, and in addition, since the viscosity of the electrolyte is increased, the load characteristics are decreased.

[Experiment 2]

[Formation of Test Cell]

### EXAMPLE 4

Li₂CO₃, NaNO₃, CO₃O₄, and Mn₂O₃ were mixed together to have a stoichiometric ratio of Na_{0.7}Li_{0.025}Co_{10/12}Mn_{2/12}O₂. Subsequently, the mixture thus prepared was held in the air at 900° C. for 10 hours, so that a sodium transition metal oxide was obtained.

A molten salt bed obtained by mixing LiNO₃ and LiOH at a molar ratio of 61 to 39 was added in an amount of five times equivalent to 5 g of the sodium transition metal oxide thus obtained and was held at 200° C. for 10 hours, so that a part of the sodium of the sodium transition metal oxide was ion-exchanged with lithium. Furthermore, a substance obtained by the ion exchange was washed with water, so that a lithium transition metal oxide was obtained.

According to the analytical result obtained by a powder x-ray diffraction method, it was found that the lithium transition metal oxide thus obtained had a crystalline structure belonging to the P6₃mc space group. In addition, quantitative determination of cobalt and manganese and that of lithium and sodium were performed by an ICP emission analysis and an atomic absorption analysis, respectively. The results are shown in Table 3.

TABLE 3

| | Sodium Transition Metal Oxide | Lithium Transition Metal Oxide |
|---|---|---|
| Example 4 | Na_{0.730}Li_{0.025}Co_{0.833}Mn_{0.167}O₂ | Na_{0.019}Li_{0.845}Co_{0.836}Mn_{0.164}O₂ |
| Example 5 | Na_{0.730}Li_{0.050}Co_{0.833}Mn_{0.167}O₂ | Na_{0.016}Li_{0.849}Co_{0.834}Mn_{0.166}O₂ |
| Example 6 | Na_{0.703}Li_{0.075}Co_{0.835}Mn_{0.165}O₂ | Na_{0.017}Li_{0.849}Co_{0.835}Mn_{0.165}O₂ |
| Example 7 | Na_{0.741}Li_{0.051}Co_{0.833}Mn_{0.167}O₂ | Na_{0.014}Li_{0.867}Co_{0.837}Mn_{0.163}O₂ |

The lithium transition metal oxide thus obtained was used as a positive electrode active material, and a test cell was formed in a manner similar to that in Example 1.

### EXAMPLE 5

A test cell was formed in a manner similar to that in Example 4 except that Li CO₃, NaNO₃, CO₃O₄, and Mn₂O₃ were mixed together to have a stoichiometric ratio of Na_{0.7}Li_{0.05}Co_{10/12}Mn_{2/12}O₂.

### EXAMPLE 6

A test cell was formed in a manner similar to that in Example 4 except that Li CO₃, NaNO₃, CO₃O₄, and Mn₂O₃ were mixed together to have a stoichiometric ratio of Na_{0.7}Li_{0.075}Co^{10/12}Mn_{2/12}O₂.

### EXAMPLE 7

Li₂CO₃, NaNO₃, CO₃O₄, and Mn₂O₃ were mixed together to have a stoichiometric ratio of Na_{0.7}Li_{0.05}Co_{10/12}Mn_{2/12}O₂. Subsequently, the mixture thus prepared was held in the air at 800° C. for 10 hours, so that a sodium transition metal oxide was obtained. Hereinafter, a test cell was formed in a manner similar to that in Example 4.

### COMPARATIVE EXAMPLES 4 TO 7

Test cells were formed in a manner similar to that in Examples 4 to 7 except that as the nonaqueous electrolyte, a solution was used which was prepared by dissolving LiPF₆ in a nonaqueous electrolyte containing ethylene carbonate (EC) and diethylene carbonate (DEC) at a volume ratio of 3 to 7 to have a concentration of 1.0 mol/l.

[Charge-Discharge Cycle Test]

The test cells of Examples 4 to 7 and Comparative Examples 4 to 7 were evaluated as follows. After the test cell was charged at a constant current of 0.2It until the positive electrode potential reached 4.8 V (vs. Li/Li⁺), charge was performed at a constant voltage of 4.8 V (vs. Li/Li⁺) until the current reached 0.05 It. Subsequently, discharge was performed at a constant current of 0.2 It until the positive electrode potential reached 3.2 V (vs. Li/Li⁺). A value obtained by dividing the discharge capacity by the charge capacity was multiplied by 100 to obtain the charge-discharge efficiency (%), and the results are shown in Table 4.

TABLE 4

| | Charge Capacity | Discharge Capacity | Charge-Discharge |
|---|---|---|---|
| | Density | Density | Efficiency |
| | (mAh/g) | (mAh/g) | (%) |
| Example 4 | 212.2 | 209.6 | 98.8 |
| Example 5 | 221.0 | 218.0 | 98.6 |
| Example 6 | 215.3 | 212.1 | 98.5 |
| Example 7 | 212.1 | 209.5 | 98.8 |
| Comparative | 212.8 | 207.1 | 97.3 |
| Example 4 | | | |
| Comparative | 218.1 | 212.9 | 97.6 |
| Example 5 | | | |
| Comparative | 212.2 | 207.6 | 97.8 |
| Example 6 | | | |
| Comparative | 215.6 | 207.2 | 96.1 |
| Example 7 | | | |

From Table 4, it is found that in Examples 4 to 7 in which 4,5-difluoroethylene carbonate (DFEC) and methyl 3,3,3-trifluoropropionate (F-MP) are contained in the nonaqueous electrolyte, the charge-discharge efficiency is improved as compared to that in Comparative Examples 4 to 7 in which ethylene carbonate (EC) and diethylene carbonate (DEC) are contained in the nonaqueous electrolyte. The reason for this is believed that when a fluorinated cyclic carbonate ester and a fluorinated chain ester are used in combination with a positive electrode active material having a crystalline structure belonging to the P6₃mc structure, a coating film which enables insertion and extraction of lithium to be smooth is formed on the positive electrode active material.

It is found that in Examples 4 and 5 in which the amount of Li in the sodium transition metal oxide is 0.025 to 0.050, the charge-discharge efficiency is improved as compared to that in Comparative Example 6 in which the amount of Li in the sodium transition metal oxide is 0.075. The reason for this is believed that when the amount of Li in the sodium transition metal oxide is 0.025 to 0.050, a coating film which enables insertion and extraction of lithium to be smooth is formed on the positive electrode active material. On the other hand, although the reason has not been clearly understood, it is found that in Comparative Examples 4 and 5 in which the amount of Li in the sodium transition metal oxide is 0.025 to 0.050, the charge-discharge efficiency is further decreased as compared to that in Comparative Example 6 in which the amount of Li in the sodium transition metal oxide is 0.075.

### Reference Signs List

1 working electrode

2 counter electrode

3 reference electrode

4 separator

5 nonaqueous electrolyte

6 container

7 current collector tab

1-10. (canceled)

11. A nonaqueous electrolyte battery comprising: a positive electrode containing a positive electrode active material; a negative electrode; and a nonaqueous electrolyte,
wherein the positive electrode active material contains a lithium transition metal oxide having a crystalline structure belonging to the P6₃mc space group, and
the nonaqueous electrolyte contains a fluorinated cyclic carbonate ester and a fluorinated chain ester.

12. The nonaqueous electrolyte battery according to claim 11,
wherein the lithium transition metal oxide is represented by Liₓ₁Na_{y1}Co_{α}M_{β}O_{γ}, wherein 0<x1<1.1, 0<y1≦0.05, 0.75≦α<1, 0<β≦0.25, 1.9≦γ≦2.1 and M indicates a metal element other than Co and includes at least Mn.

13. The nonaqueous electrolyte battery according to claim 11, wherein the lithium transition metal oxide is a lithium transition metal oxide which is obtained by ion exchange of a part of sodium contained in a sodium transition metal oxide represented by Liₓ₂Na_{y2}Co_{α}M_{β}O_{γ}, wherein0≦x≦0.1, 0.66<y2<0.75, 0.75≦α<1, 0<β≦0.25, 1.9≦γ≦2.1 and M indicates a metal element other than Co and includes at least Mn, with lithium.

14. The nonaqueous electrolyte battery according to claim 12,
wherein the lithium transition metal oxide is a lithium transition metal oxide which is obtained by ion exchange of a part of sodium contained in a sodium transition metal oxide represented by Liₓ₂Na_{y2}Co_{α}M_{β}O_{γ}, wherein 0≦x2≦0.1, 0.66<y2<0.75, 0.75≦α<1, 0<β≦0.25, 1.9≦γ≦2.1 and M indicates a metal element other than Co and includes at least Mn, with lithium.

15. The nonaqueous electrolyte battery according to claim 13,
wherein 0.025≦x2≦0.050 is satisfied.

16. The nonaqueous electrolyte battery according to claim 14,
wherein 0.025≦x2≦0.050 is satisfied.

17. The nonaqueous electrolyte battery according to claim 11,
wherein the fluorinated cyclic carbonate ester includes at least one of 4-fluoroethylene carbonate and 4,5-difluoroethylene carbonate.

18. The nonaqueous electrolyte battery according to claim 12,
wherein the fluorinated cyclic carbonate ester includes at least one of 4-fluoroethylene carbonate and 4,5-difluoroethylene carbonate.

19. The nonaqueous electrolyte battery according to claim 11,
wherein the fluorinated chain ester includes at least one of a fluorinated chain carboxylate ester and a fluorinated chain carbonate ester.

20. The nonaqueous electrolyte battery according to claim 12,
wherein the fluorinated chain ester includes at least one of a fluorinated chain carboxylate ester and a fluorinated chain carbonate ester.

21. The nonaqueous electrolyte battery according to claim 19,
wherein the fluorinated chain carboxylate ester includes methyl 3,3,3-trifluoropropionate.

22. The nonaqueous electrolyte battery according to claim 20,
wherein the fluorinated chain carboxylate ester includes methyl 3,3,3-trifluoropropionate.

23. The nonaqueous electrolyte battery according to claim 19,
wherein the fluorinated chain carbonate ester includes methyl 2,2,2-trifluoroethyl carbonate.

24. The nonaqueous electrolyte battery according to claim 20,
wherein the fluorinated chain carbonate ester includes methyl 2,2,2-trifluoroethyl carbonate.

25. The nonaqueous electrolyte battery according to claim 11,
wherein the battery is charged until the positive electrode potential is more than 4.6 V (vs. Li/Li⁺).

26. The nonaqueous electrolyte battery according to claim 12,
wherein the battery is charged until the positive electrode potential is more than 4.6 V (vs. Li/Li⁺).
